(19) United States
(12) Patent Application Publication
(10) Pub. No.: US 2025/0104151 A1
(43) Pub. Date: Mar. 27, 2025

(54) LAYERED PROCESSING FOR CONSTRAINED FUND OPTIMIZATION

(71) Applicant: HRB Innovations, Inc., Wilmington, DE (US)

(72) Inventor: Brian Bustos, Kansas City, MO (US)

(21) Appl. No.: 18/372,907

(22) Filed: Sep. 26, 2023

(51) Int. Cl. G06Q 40/06

(52) U.S. Cl. CPC G06Q 40/06

(57) ABSTRACT

Systems and methods for providing secure and efficient allocation of funds is described herein. An opportunity recognition and fund allocation system may utilize user data and law recognition to determine insights that may be used to maximize an outcome objective. Optimization of the outcome objective may provide a classification and list of action items, which, when completed, will realize the goals. The processes described herein may be separated into a primary layer and sublayers that are only accessible by specific processes. The layering described herein organize the data in such a way that creates a hierarchy of rules. This allows for a single platform to be used for all users regardless of location and applicable state and federal laws associated with the location of the user.

### FIELD

Some embodiments described herein are directed to customizable fund distribution. Specifically, embodiments of the current disclosure are directed to providing a layered fund optimization system.

### BACKGROUND

Typically, income is taken from a taxpayer's paycheck in the form of taxes paid to government regulatory agency and at the end of the year, if the taxpayer has overpaid, the taxpayer receives a refund in the form of overpayment. The overpayment is typically, planned; however, the ability to now where a taxpayer stands in a changing environment over the course of a tax year is not known. The taxpayer typically must trust that a setting at the beginning of the year will result in a desired outcome related to taxes, income, and asset allocation.

Furthermore, current tax preparation software offers disjointed applications for each of the various fields of tax management and fund allocation. The various disjointed applications provide various services such as, for example, preparation of tax-related forms in a single application and access to representatives on another platform and allocation of funds to various third-party applications across other applications. Different federal and state laws make combining any tax-related software into a single accessible and customizable platform extremely difficult.

What is needed is an integrated system that stores the tax data in quickly recognizable and efficient data structures for integration of applications and/or services on a single platform.

### SUMMARY

Generally, embodiments of the present disclosure provide solutions to the above-described problems. Some embodiments of the current disclosure provide optimized fund allocation based on machine learning and statistical algorithms determining insights and action items that maximize objective functions to realize user defined goals. The system provides sets of processes running on primary layer where each process of the sets of processes directly accesses separate sublayers providing stored data a functions optimize fund allocation while constraining the outcome objectives to applicable state and federal laws.

A first embodiment is directed to one or more non-transitory computer-readable media storing computer executable instructions that, when executed by at least one processor, performs a method of determining an optimal outcome. The method comprises obtaining, by a calculation module at a primary layer, data points indicative of a user and a user region associated with the user and a set of government laws comprising federal and state laws based on the user region, wherein the data points and federal laws are stored at a sublayer, generating, by the calculation module, a user profile comprising the data points and the set of government laws, obtaining, by an insight module at the primary layer, the user profile, determining, by the insight module, insights from the user profile, wherein the insight module does not have direct access to the sublayer, obtaining, by a goal module at the primary layer, a set of goals from the user, generating an outcome objective based on the set of goals from the user and the insights, and determining a set of action items that maximizes the outcome objective while constraining the outcome objective to the set of government laws.

A second embodiment is directed to a system for determining an optimal outcome. The system comprises at least one processor, a datastore, and one or more non-transitory computer-readable media storing computer-executable instructions that, when executed by the at least one processor, perform a method of determining the optimal outcome. The method comprises obtaining, by a calculation module at a primary layer, data points indicative of a user and a user region associated with the user and a set of government laws comprising federal and state laws based on the user region, wherein the data points and federal laws are stored at a first sublayer, generating, by the calculation module, a user profile comprising the data points and the set of government laws, obtaining, by an insight module at the primary layer, the user profile, determining, by the insight module, insights from the user profile, wherein the insight module does not have direct access to the first sublayer, determining, at a second sublayer, guidance for the user based on the insights, providing the guidance to the user by the insight module, obtaining, by a goal module at the primary layer, a set of goals from the user, generating an outcome objective based on the set of goals from the user and the insights, and determining a set of action items that maximizes the outcome objective while constraining the outcome objective to the set of government laws.

A third embodiment is directed to method of determining an optimal outcome. The method comprises obtaining, by a calculation module at a primary layer, data points indicative of a user and a user region associated with the user and a set of government laws comprising federal and state laws based on the user region, wherein the data points and federal laws are stored at a first sublayer, generating, by the calculation module, a user profile comprising the data points and the set of government laws, obtaining, by an insight module at the primary layer, the user profile, determining, by the insight module, insights from the user profile, wherein the insight module does not have direct access to the first sublayer, determining, at a second sublayer, guidance for the user based on the insights, providing the guidance to the user by the insight module, obtaining, by a goal module at the primary layer, a set of goals from the user, generating an outcome objective based on the set of goals from the user and the insights, determining a set of action items that maximizes the outcome objective while constraining the outcome objective to the set of government laws, and presenting the set of action items to the user by a graphical user interface.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

### BRIEF DESCRIPTION OF THE DRAWING FIGURES

Embodiments of the disclosure are described in detail below with reference to the attached drawing figures, wherein:

FIG. 1 depicts an exemplary hardware system for embodiments of the disclosure;

FIG. 2 depicts an exemplary layered goal optimization system;

FIG. 3 depicts an exemplary workflow associated with the exemplary layered goal optimization system of claim;

FIG. 4 depicts exemplary graphical user interfaces generated for display by the exemplary layered goal optimization system of FIG. 2; and

FIG. 5 depicts an exemplary process of optimizing an outcome objective to determine action items to realize goals of a user.

The drawing figures do not limit the disclosure to the specific embodiments disclosed and described herein. The drawings are not necessarily to scale, emphasis instead being placed upon clearly illustrating the principles of the disclosure.

### DETAILED DESCRIPTION

The following detailed description references the accompanying drawings that illustrate specific embodiments in which the current disclosure can be practiced. The embodiments are intended to describe aspects in sufficient detail to enable those skilled in the art to practice those embodiments of the disclosure. Other embodiments can be utilized, and changes can be made without departing from the scope of the current disclosure. The following detailed description is, therefore, not to be taken in a limiting sense. The scope of the disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

Generally, embodiments of the present disclosure relate to providing user access to tax-related data associations and providing the user the ability customize the tax-related data based on goals such that the user controls their own financial plan. In some embodiments, the user may provide links between data sets and manipulation of various data sets by customizing taxes and fund allocation using rules within a strictly governmentally regulated space. The overriding rules of the data management within the system may be provided by federal and state agencies; however, additional rules may be applied within those state and federal rules to allow users to control tax-related data sets to allocate funds and control their financial future. As such, the user may have access to tax data manipulation through specifically configured layered networks that regulate rules and access. The layered network provides a computing system that is specifically structured to allow user control while maintaining the strict governmental regulations across the awareness of new laws and optimization of the user's funds based on user-defined goals.

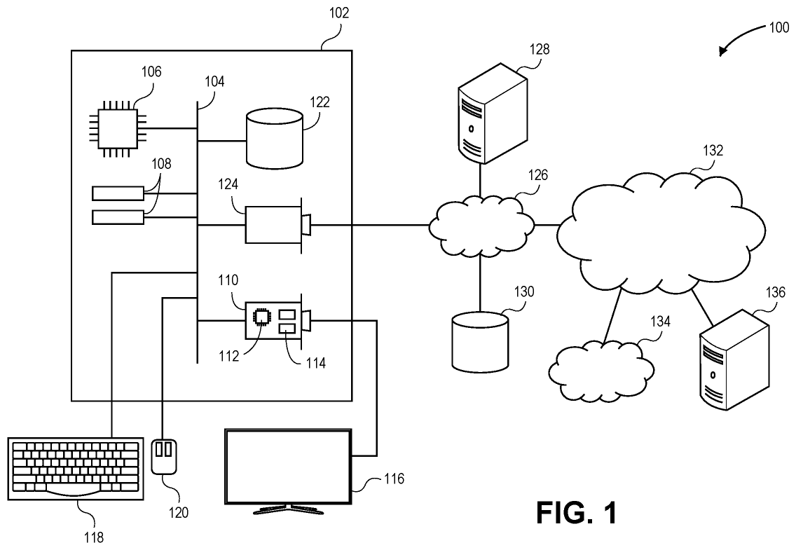

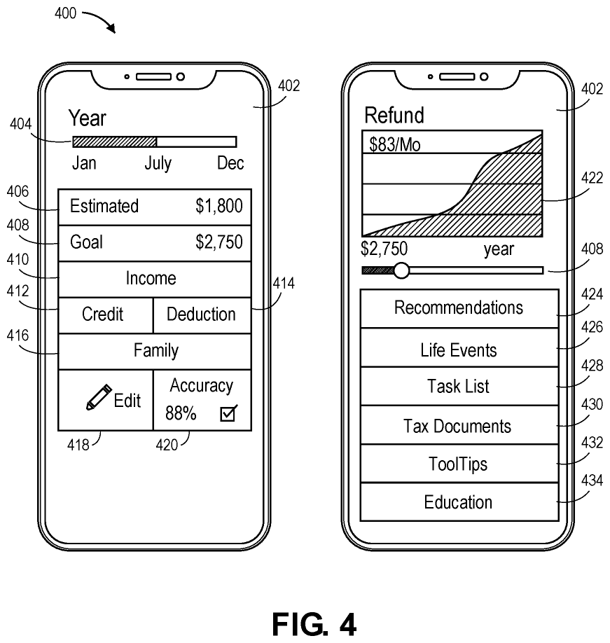

FIG. 1 illustrates one example of a hardware platform representative of an embodiment of hardware system 100 that may comprise data management and visualization system 200 in the embodiments described below. Computer 102 can be any computer associated with or providing a vehicle instrument cluster and/or any form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple buses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card but rather may be integrated into the motherboard or the CPU 106. In some embodiments, graphics card 110 has a separate graphics processing unit (GPU) 112, which can be used for graphics processing or for general-purpose computing (GPGPU). GPU 112 may provide graphics and icon generation and validation as described in embodiments below. Also on graphics card 110 is GPU memory 114. Connected (directly or indirectly) to graphics card 110 is display 116 for user interaction. In some embodiments, no display is present, while in others, it is integrated into computer 102. In some embodiments, display 116 is configured to display GUI 400 (FIG. 4). Similarly, peripherals such as keyboard 118 and mouse 120 are connected to system bus 104. Like display 116, these peripherals may be integrated into computer 102 or absent and may be provided as inputs by display 116. Also connected to system bus 104 is local storage 122, which may be any form of computer-readable media and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store non-transitory data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations. In particular, computer-readable media includes non-transitory computer-readable media storing computer-executable instructions that, when executed, cause one or more processors to carry out operations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein, such as backup or versioning. Data stores can be local to a single computer, such as computer 128, accessible on a local network, such as local network 126, or remotely accessible over Internet 132. Local network 126 is, in turn, connected to Internet 132, which connects many networks such as local network 126, remote network 134, or directly attached computers such as computer 136. In some embodiments, computer 102 can itself be directly connected to Internet 132.

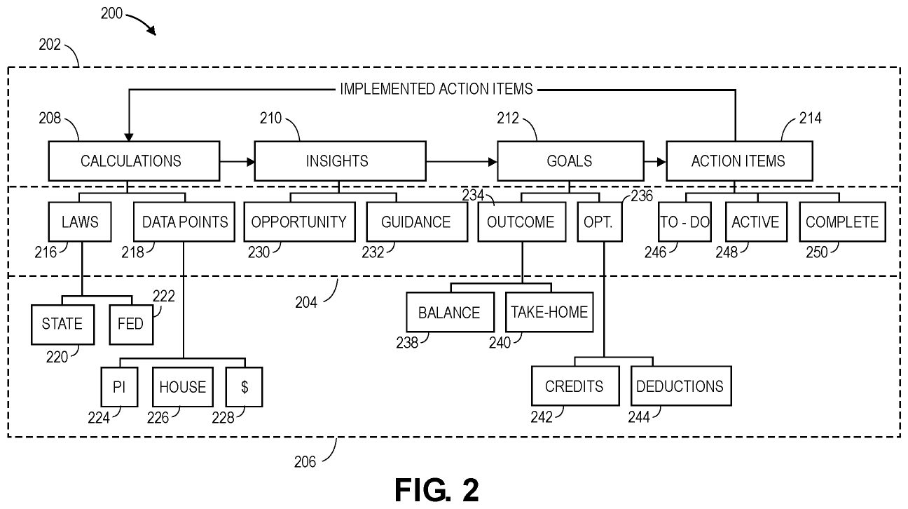

In some embodiments, opportunity recognition and fund allocation system 200 may provide layers of complexity to handle the various government laws and user goals. As depicted in FIG. 2, opportunity recognition and fund allocation system 200 may obtain data from various sources including the user (e.g., taxpayer), other users, historical tax data, government entities, and the like. In some embodiments, the data may be stored in a secure database on a secure server accessible by the users given the associated security access and, in some embodiments, the government entities. In some embodiments, the data across various layers described below may be accessible by third-party applications if given authorization by the user and government entities.

Furthermore, access may be provided to various third-party entities providing third-party applications. For example, third-party entities may be financial institutions, creditors, financial management services, and the like. This way all debts and assets of the taxpayer may be tracked and managed from a single device and through a single system (i.e., opportunity recognition and fund allocation system 200). Furthermore, access to all of the above-described data allows opportunity recognition and fund allocation system 200 to receive input from the user and allocate instructions to each third-party institution for providing full customization and control to the user.

In some embodiments, opportunity recognition and fund allocation system 200 comprises a plurality of layers comprising primary layer 202, first sublayer 204, and second sublayer 206. Furthermore, each layer comprises various functions and stored data, which may or may not be accessible by other layers or functions. Separation of each layer and process within each layer allows efficient data processing and optimization of user goals while maintaining a hierarchy of rules set forth by government agencies and the user. In some embodiments, each sublayer of plurality of sublayers may be associated with each corresponding process of main layer 202 as shown in FIG. 2. As such, each sublayer may be distinct and accessible by only the corresponding function in main layer 202. Furthermore, each sublayer may comprise different security such that each sublayer is only accessible with the corresponding security information. Each process of main layer 202 may comprise the necessary security data to access the data command processing of each corresponding sublayer of the plurality of sublayers.

As shown in FIG. 2, the first process in main layer 202 is calculations module 208. In some embodiments, main layer 202 is an iterative process for determining an optimal outcome based on objectives. As such, calculations module 208 being the “first” process in the loop, is exemplary and may be a second, third, etc. process of main layer 202 depending on the starting point.

In some embodiments, calculations module 208 may obtain data and perform certain calculations based on the obtained data and expected outcomes and/or general applicable rules. The obtained data may be laws 216 providing a set of rules at a top of a rules hierarchy that must be followed above any other user applied rules. The laws 216 may be a set of laws provided by a regulatory agency such as a financial entity of a government body such as, for example, the Department of the Treasury, Federal Housing and Finance Agency, and/or the Internal Revenue Service (IRS). Furthermore, laws 216 may comprise state laws 220 and federal laws 222. As such, user location data may be used to determine the laws that apply for each individual. Calculations module 208 may calculate known user data associated with the user including data points 218 to calculate user financial information associated with laws 216.

In some embodiments, calculations module 208 may obtain data points 218 indicative of and associated with the user. Data points 218 may comprise any information that may be useful in verifying the user and communicating with the user. Furthermore, data points 218 may include any data used in the analysis of taxes and goals of the user. The data points may include tax related data such as, for example, the user's history of tax filings, assets, business expenses, income, debts, and any other credits and debts that may be applied to optimize an object to receive the best outcome. As such, all information related to the user may be stored as data points 218 for maximizing an objective.

In some embodiments, calculations module 208 may comprise performing preliminary calculations based on data points 218 and laws 216. These calculations may determine base values of the outcome for the user and may be stored as a profile of the user. The profile of the user may be used for comparison and as a starting point for determining insights and applying machine learning algorithms to optimize objectives. As such, the profile (including data points 218 and laws 216) may be a typical tax outcome that is calculated without the additional insights, goals, and optimizations described herein. In some embodiments, the user is associated with the particular laws of region in which the user is located. This allows preliminary calculation of the user's taxes based on only applicable laws.

In some embodiments, insights module 210, as described herein, comprises functionality for seeking out and finding opportunities 230, of first sublayer 204, from any available data including calculations module 208 output. Opportunities 230 may define objectives or may be used to maximize objectives. For example, opportunities 230 may be in the form of new laws that provide tax relief to student loan debts for barrowers that make a yearly income below a threshold value. This opportunity may be discovered by automatically analyzing the new tax law data and income data from user data in calculations module 208. The output of calculations module 208 may then be sent to insights module 210 where it is determined that the tax relief associated with the student loan relief can be applied to the user and. As such, the student loan relief opportunity may be realized and applied to the user's profile. Opportunities 230, therefore, may be an algorithm for analyzing the output of calculations module 208 for changes that may positively impact the outcome objective of the user.

In some embodiments, if it is determined that insights do not positively impact the outcome objective or is a positive impact but below a threshold value, the process does not move on to optimizing the outcome objective and determining action items. This preliminary check may be performed to save unnecessary processing and notifications to the user for action items that will not benefit the user given the associated outcome. For example, a preliminary calculation may determine that the benefit of the new tax law will only increase the user's tax return from $3,000 to $3,005. However, the user must fill out three forms that may take several hours, and therefore it not worth it to the user to continue the process of optimizing the outcome objective.

Furthermore, guidance 232 may provide a communication link to an automatic help algorithm or a human representative to assist the user. In some embodiments, the user may interact with GUI 400 (FIG. 4) to access guidance 232. Guidance 232 may be unsolicited or solicited and may provide the user with insights module 210 that may positively impact (or avoid negative impact) the user's credit, debts, assets, tax return, paycheck, or the like. As described in the example above, the new student loan tax relief may be a new law, discovered in calculations module 208, that may positively reflect the users tax refund. The user may or may not know about this law; however, when opportunity recognition and fund allocation system 200 learns of the new law, the user may be made aware of how this new law can be applied to the user's benefit at guidance 232. This assists the user in forming their own goals and desired outcomes of their taxes.

In some embodiments, guidance 232 may be provided without solicitation by simply causing display of new benefits that affect the user. Guidance 232 may be provided by GUI 400 and opportunity recognition and fund allocation system 200 may notify the user with alerts, text messages, emails, and the like. An important aspect of the current disclosure, discussed in more detail below, is that the opportunity recognition and fund allocation system 200 may run continuously and update in real time. As such, when a new law is passed, calculations module 208 and insights module 210 (including guidance 232) updates, recognizes the new law, calculates a preliminary potential benefit to the user, and notifies the user. This way the user may always be up to date with any changes in federal laws 222 and state laws 220 to maximize their portfolio.

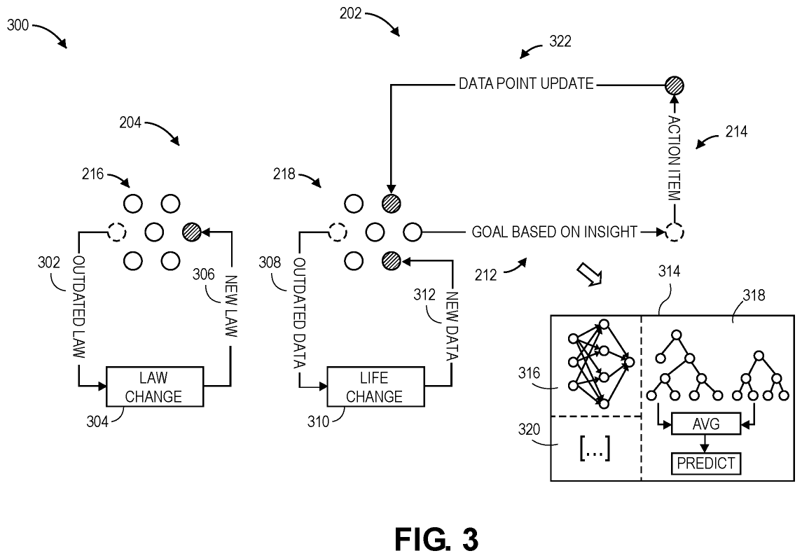

Goals module 212, in some embodiments, comprises outcome desires of the user. Goals may be provided by the user in the form of text descriptions and/or selection by the user of recommendations provided by opportunity recognition and fund allocation system 200. Goals may be obtained from the user through any of the various GUI provided in FIG. 4 and stored and processed at goals module 212. Goals may be provided to the user for selection by GUI 400. Provided goals may be retrieved from a history of the user, for example, provided goals may be past goals, new goals, based on tax changes and/or law changes 304 (FIG. 3) as described in more detail below. The provided goals for selection by the user may be, for example, maximizing a tax return, maximizing paychecks while constraining an estimated return to be nonnegative or positive, allocation of a portion of income to various assets for maximizing yearly assets during a tax year, and the like. Any goals based on calculations module 208 and insights module 210 may be provided to the user by goals module 212 causing display of goals by GUI 400.

In some embodiments, the user may provide goals module 212 by text input. The user may provide any text into GUI 400 in a specific field for adding goals module 212. Opportunity recognition and fund allocation system 200 may recognize the text through a semantic language recognition algorithm and classify the text goal input into a set of stored goals and outcome objectives. In some embodiments, the algorithm may create a new outcome objective by classifying the goal along with a new law or new data point change to create a new classification based on insights as described below in reference to FIG. 3. Using the loan forgiveness tax relief program example above, the classification may be to maximize a tax refund while constraining an amount paid in for each paycheck. However, new insights may provide additional tax return money from the loan forgiveness relief program. As such, a new classification may be created weighing an estimated relief fund against the tax return and increasing the available income on each paycheck.

Outcome 234, in some embodiments, provides desired outcomes based on the user-defined goals as well as objectives set by opportunity recognition and fund allocation system 200. In some embodiments, outcome 234 may simply be the user-defined goals, such as, for example, maximum tax return with a variable percentage taken out of paychecks with maximum and minimum threshold values, maximize paycheck while constraining tax return amount, allocation of funds between various accounts, and the like. Any outcomes may be applied at outcome 234 for applying optimization techniques for realizing the applied outcome 234. In some embodiments, these outcomes may be defined by balance 238 and take-home 240, where balance 238 refers to a balanced tax return and paycheck and take-home 240 refers to a maximum paycheck with constraints on the tax return. In some embodiments, outcome 234 may be referenced herein as outcome objective for input into the optimization algorithms of optimization 236.

At optimization 236, opportunity recognition and fund allocation system 200 runs algorithms against outcome 234 to maximize the outcome objective function that realizes the applied outcome 234. At this point, all insights and outcome 234 have been gathered. The outcome 234 and insights may then be input into optimization algorithms as parameters for optimization.

In some embodiments, machine learning algorithms may be trained on data to optimize the outcome objectives. In some embodiments, outcome objectives may be income, diversity (balance 238), risk avoidance, as well as any of the above-described goals and combinations thereof, and the like. In some embodiments, objectives may comprise goals received from the user and/or objectives may be a redefinition of goals for input into the machine learning algorithms for obtaining the desired outcomes. The statistical and machine learning algorithms used to optimize the objective outcome and classify the action items is described in detail below in reference to FIG. 3.

In some embodiments, outcome objectives may be optimized by accessing, and based on, credits 242 and deductions 244. Credits 242 may include any childcare credits, business credits, personal credits based on data points 218 and the like. Deductions 244 may be any tax deductions related to family, business, age, and the like. Any data indicative of the user may be obtained from data points 218 to calculate goals based on insights using credits 242 and deductions 244. The output of goals module 212 may be list of optimized action items that need to be completed to realize the goals.

After goals module 212, the processed data may move next to action items module 214. Action items module 214 may store data and manage functions at first sublayer 204 including to-do 246 active 248 and complete 250. To-do 246 may comprise a list of items that need to be completed to realize the user defined goals. For example, goals module 212 may output an outcome that optimizes the user's tax return for a period of one month when the user receives a bonus check for the year (e.g., December). This may be included in data points 218, income 228 and presented to insights module 210 where it is determined that a different optimization for December may benefit the user. At goals module 212 the outcome may be determined based on optimization of the user goals using the algorithms described above. The outcome may be a modified tax withholding for December that maximizes the users take-home/tax return based on the user's goals. This modified tax withholding may be presented to action items module 214 and stored at to-do 246. The modified tax withholding may be implemented by modifying the user's tax withholding for the month of December as determined by the optimization algorithm and returned to calculations module 208 as this process is iterative. For the month of December, this modified tax withholding may be saved at active 248, and when December is complete, a new tax withholding for the next year may be determined, and the December withholding may be moved to complete 250 and stored at data points 218 for future use.

FIG. 3 further illustrates workflow process 300 of opportunity recognition and fund allocation system 200. Workflow process 300, in some embodiments, includes primary layer 202 in communication with first sublayer 204 where first sublayer 204 includes updates to laws 216 and data points 218. Furthermore, second sublayer 206 may be part of workflow process 300, but for simplicity, is not shown here. At laws 216, law change 304 replaces outdated law 302 with new law 306. New law 306 is stored as a data point in in laws 216 for inputting insights into the optimization algorithms described above. Furthermore, in this example, life changes 310 replaces outdated data point 308 with new data point 312. Life changes 310 could include any new life event such as, for example, a new house, a new job, a new location, a new vehicle, a new dependent, or the like. Any life changes 310 that may affect the outcomes and action items of opportunity recognition and fund allocation system 200 may be included as data points 218 and may be updated periodically or continuously.

When first sublayer 204 is updated with new laws 306 and new data points 312, the updated data may be sent to primary layer 202 where the analysis described above is performed. New insights may be determined at insights module 210 from the updated data then goals module 212 may be updated based on the new insights. New outcomes may be determined based on goals module 212 and insights module 210 by the optimization algorithms comprising exemplary neural network 316, random forest 318, and any other statistical and/or machine learning algorithm 320 (e.g., cluster, Bayesian, decision tree, etc.). Any classification and/or regression algorithms for determine optimized outcomes based on goals module 212 and insights module 210 may be used as described in embodiments above. New outcomes may be sent to the action items module 214 where a new action item is created and implemented as described above. The implementation of the action items may create new data points 322 to be stored in data points 218.

Exemplary statistical and machine learning algorithms 314 may optimize the outcome objective and classify action items that realize the goals based on the outcome objective. In some embodiments, preconditioning may serve to standardize the data for analysis for machine learning models, decision trees and/or random forest 318, or other statistical and/or machine learning algorithms 320, and/or the output by insights module 210 may be feature engineered for more efficient analysis and quicker convergence of optimized results. The user data may be filtered using feature engineering models to maximize rewards, representative of the outcome objectives, for providing the best data to the predictive algorithms. When data sets are found to have little or no effect on the outcome objective, these data sets may be eliminated from the user set for analysis in the predictive models. As such, a preliminary filter may be provided to efficiently process the user data in the predictive phases.

In some embodiments, the insights and data points input into the feature engineering model may be processed to determine features for input into the predictive models. Generating these features may reduce the total variables processed by the predictive model saving time and processing power during the inference phase of the predictive models. When the training phase is complete, the final model comprising the final features may be put into use processing new data as input by the users of opportunity recognition and fund allocation system. In this way only variables that are useful to the given conditions may be used.

After the user data and insights have been filtered for more efficient and affective analysis, the data may be fed into the predictive models, or “matching” phase. The matching phase may comprise one or more machine learning algorithms trained for matching action items to goals to maximize the outcome objective. Here, the outcome objective may be any desired outcome representative of goals and/or insights as described above. As such, completion of the action items serves to realize (or complete) the goals and insights.

In some embodiments, the analysis may be performed by neural network 316, decision trees and/or random forest 318, or other statistical and/or machine learning algorithms 320 including clustering, optimal and greedy matching, regression analysis, and the like for determining the best fit for the goals and insights with the action items to maximize the outcome objective, which is a function representative of the goals and insights to be realized. In some embodiments, the outcome objective is the goals and insights to be realized and the trained matching algorithm matches the optimal action items to the goals that has a “best” history of achieving, or realizing, those goals. As such, the action items with the highest likelihood of successfully achieving the goals are presented to the user or automatically carried out by implementation and/or sending to third-party application for completion.

FIG. 4 depicts exemplary GUI 400. In some embodiments, GUI 400 comprises an interface for the user to interact with the application of opportunity recognition and fund allocation system 200. GUI page 402 comprises various features for which the user may interact and provides the functionality for optimizing the outcome objectives as described above. Here, many features of opportunity recognition and fund allocation system 200 are explained by way of GUI 400. It should be understood that the systems and workflows of FIGS. 1-3 may be implemented to perform the functions described in relation to GUI 400 presented in FIG. 4. Any features provided on GUI page 402 may be interchanged or included on any page presented by GUI 400. As such, the user input of GUI 400 may initiate the functionality of opportunity recognition and fund allocation system 200 described above.

In some embodiments, GUI page 402 may provide exemplary timeline 404. Timeline 404 may provide a representation of the tax year, current date and time, and time periods where specific rules apply. For example, December may be highlighted based on the above-described modified tax withholdings for December. Furthermore, based on the student loan tax relief plan described above, the period from when that new tax law is applicable may be highlighted. This provides a visual indicator to the user of when various action items of action items module 214 may be implemented. Furthermore, the user may select timeline 404 and add goals module 212 for specific periods.

In some embodiments, the application provides year-round visibility and engagement to the user from opportunity recognition and fund allocation system 200 by GUI 400. Opportunity recognition and fund allocation system 200 may update periodically (e.g., daily, weekly, monthly, etc.), continuously (as quickly as network connections and processing provide), or each time a change is detected. For example, opportunity recognition and fund allocation system 200 may only monitor and/or run periodic checks on laws 216, data points 218, and any other data that may change the outcomes and action items of action items module 214. Data points 218 may be changed based on life changes 310 as described above or user input with goal changes. As such, processing may be saved by only checking for changes or receiving input from the user rather than continually running the optimization algorithms.

In some embodiments, estimated outcome 406 may be presented. For example, estimated outcome 406 may present an estimated tax refund of $1,800. The estimated tax refund may be estimated based on current settings or current and future settings. As shown, the current date is sometime in July. The estimated tax return may be based on current settings including the modified monthly withholdings of December. Furthermore, the estimated tax return may only display the current withholdings to date. As such, the user may be on track to meet displayed goal field 408 or modifications may be necessary. If modifications are necessary, opportunity recognition and fund allocation system 200 may automatically perform the necessary modifications to stay on track and notify the user, or opportunity recognition and fund allocation system 200 may request permission and provide guidance to the user to stay on track.

Goal field 408, may display any goal associated with goals module 212. Here, the displayed goal, for example, is a tax refund goal. The user may wish to withhold extra income to have a tax return of $2,750. The user may set this as a user goal and opportunity recognition and fund allocation system 200 may adjust tax withholdings throughout the year to accomplish this goal. As such, the following year, the user receives a tax refund of approximately $2,750.

GUI 400 provided by the application generated by opportunity recognition and fund allocation system 200 may provide income field 410. Income field 410 may display the income of the user for the designated tax year. The income may be tracked through integrations with third-party income and financial applications and/or may simply be input by the user. When a change is detected, either through input by the user or automatically through integration with the third-party applications, opportunity recognition and fund allocation system 200 may evaluate if the change affects the outcomes. If the change will affect the outcome, then a new optimization may be run according to the above-described embodiments.

In some embodiments, credits field 412 and deductions field 414 may be presented. Here, the user may view and/or select and update credits 242 and deductions 244. Credits field 412 and deductions field 414 may be obtained from input by the user or may be obtained from integrations with third-party financial and asset applications.

GUI 400 may provide family field 416. Here, opportunity recognition and fund allocation system 200 may provide any information associated with the user and their family. The information may be marriage status, dependent information, and the like. Furthermore, the user may select family field 416 and update data points 218 associated with their family. At edit button 418, the user may edit any data points 218 and features associated with opportunity recognition and fund allocation system 200.

In some embodiments, GUI 400 may present accuracy field 420. Accuracy field 420 may be a presentation of an estimated accuracy of estimated outcome 406. The estimated accuracy may be based on a likelihood of correctness of the information stored in laws 216 and data points 218 as well as any other data, calculations, and estimations. For example, the tax return estimate may be based on current settings and currently known laws and data points; however, this may not include potential changes to each, which may change based on a probability determined as an average and/or an average rate of past changes.

Furthermore, in some embodiments, accuracy field 420 may be determined based on time. Time until a goal is realized may directly impact the accuracy of a goal prediction. For example, the tax refund estimate may be more accurate in December than in July because there is less time for changes reducing a likelihood of change to laws 216 and data points 218. In some embodiments, the accuracy based on time may be quantified by averaging a history of each variable, or goal. Continuing with the tax refund estimate example, a history of change rate and change rate error may be quantified for tax refund estimates of the user as well as other users. These averages may be weighted to provided optimal accuracy by minimizing a least squares algorithm and/or by applying the machine learning algorithms described above. Accuracy may be impacted by variable such as laws 216, data points 218, engagement, time since last update, time until a goal is realized, and the like and may or may not be displayed to the user. As shown accuracy field 420 is presented as a percentage with a check representing that the percentage is above a threshold value indicating a good standing; however, the accuracy may be represented in any quantifiable way such as, for example, a number, ranking, line or bar chart, and/or the like.

In some embodiments, when accuracy field 420 drops below a threshold value, a notification may be sent to the user to update certain information. Laws 216 and data points 218 may further be evaluated for accuracy and if the user information has not been updated, or if changes are detected, the accuracy score may drop. As such, receiving confirmation of data changes from the user may increase the accuracy score, which may then be displayed at accuracy field 420.

Continuing with the exemplary embodiment of GUI page 402, GUI 400 presents a tracking tool 422 for tracking goal realization in real time. In some embodiments, tracking tool 422 may display a visualization for illustrating the real-time realization of each goal. As shown, the tax refund goal is $2,750 with an excess withholding of $83/month. The settings applied for the year show the refund increasing on the chart to the desired amount over the course of the year. An evaluation of the accuracy of the estimate may also be provided as described above.

Recommendations field 424 may provide recommendations from a representative or automatically via opportunity recognition and fund allocation system 200. In some embodiments, the application, via GUI 400, may facilitate communication between the user and a client representative. The user may select recommendations field 424 and be placed in chat, textual, and/or voice communication with the client representative. In some embodiments, the client representative is a person. Here, the user may receive information from insights module 210 providing guidance 232.

In some embodiments the client representative is a voice/text recognition and response algorithm. The client representative may be configured to interact with the user and provide recommendations based on insights of insights module 210 and goals of goals module 212. In some embodiments, the client representative may be configured to recommend goals of goals module 212 or recommend modifications to goals based on insights module 210 and optimization outcomes. For example, recommendations may include updating user information to increase accuracy scores, including potentially missed credits and debits, and the like.

GUI 400 may present life events field 426. Life events field 426 may provide a display of life events of the user for timeline 404 (e.g., tax year). Life events field 426 may receive input by the user for adding/updating life events. When the life events are updated, the task is entered as life changes 310 and outdated data points 308 may be replaced with new data points 312 as described in embodiments above. The user input may initiate new optimization calculation if the new input impacts the current goals and outcomes. The user may enter any life changes via GUI 400.

GUI 400 may present task list field 428. Task list field 428 may include any tasks that the user must complete to realize their goals. For example, task list field may include a task of using all Health Savings Account (HSA) and allocating a percentage of their income to investments and/or changing a withholding amount, and the like. Task list field 428 may provide access to the user's accounts and may link other accounts through third-party integrations.

GUI 400 may present tax documents field 430. Tax documents field 430 may provide the user access to any documents that may need filing to update any information associated with the user's status regarding taxes. Here, the user may access a full interview for tax filing purposes (e.g., W4 form), which, in some embodiments, may already be completed or partially completed based on the ongoing updates by the user with opportunity recognition and fund allocation system 200.

GUI 400 may provide tooltips field 432 and education field 434. In some embodiments, tooltips field 432 may provide the user with self-help material such as term definitions, data point explanations, tax data explanations, and the like. Tooltips field 432 may provide the user with the ability to answer any questions the user may have on their own. Similarly, education field 434 may provide user examples and simulations of content such that the user may engage with the content to better understand all that opportunity recognition and fund allocation system 200 has to offer.

Any of the above-described inputs and calculations associated with GUI 400 may be used as inputs into opportunity recognition and fund allocation system 200 for analysis and determining the action items necessary to achieve goals of goals module 212.

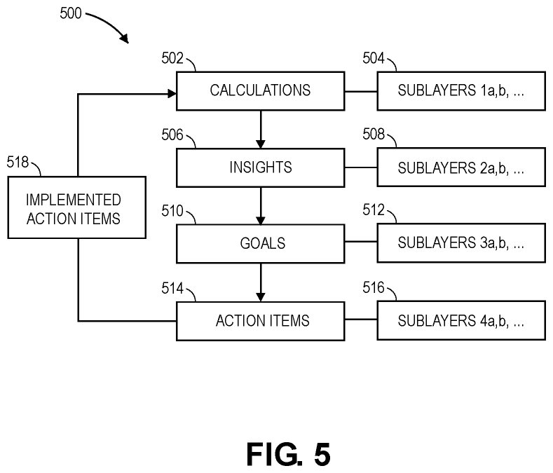

FIG. 5 depicts an exemplary process 500 of providing optimized outcomes through opportunity recognition and fund allocation system 200. At step 502, calculations of calculations module 208 may be implemented as described above. In some embodiments, calculations module 208 may comprise calculating user associated data including tax data and formulating a profile of the user based on the user data, locations, and laws associated with the locations. At step 504, calculations may access sublayers to obtain data associated with the user including data points 218 and laws 216. Further sublayers may be accessed including state laws 220, federal laws 222, location 224, assets and family 226, and income 228 as described in embodiments above. Calculations module 208 may provide a profile for the user including preliminary tax data and move the data to insights module 210 at step 508.

At step 506, insights module 210 may receive the output data from calculations module 208 and analyze the data for potential insights. In some embodiments, insights module 210 may access sublayers at step 508 to determine opportunities 230 to increase take-home income of the user. These opportunities 230 may be in the form of new laws 306 and how these new laws 306 relate to the user based on the data points 218. In some embodiments, opportunities 230 may be based on new data points 312 indicative of life changes 310 of the user.

At step 510, output data from insights is received at goals module 212. Goals module 212 may receive input from the user defining user goals associated with tax returns, income allocations, and the like as described in embodiments above. Furthermore, goals module 212 may access sublayers at step 512, the sublayers comprising, analyzing, and calculating, outcome 234 from balance 238 and take-home 240, as well as performing optimizations based on credits and deductions. Goals module 212 may determine optimized outcomes based on insights and requested goals of the user using statistical and machine learning algorithms as described above.

At step 514, action items module 214 may receive the output data from goals module 212. Action items module 214 may generate new action items based on new data from goals module 212. The new action items may be labeled and stored in a sublayer in step 514 as to-do 246 and may be implemented automatically or by notifying the user as described above. The sublayer may further comprise active 248 action items and completed 250 action items. Action items module 214 may generate new action items based on goals module 212 and facilitate application of the new action items. In some embodiments, action items module 214 may access and stored data at sublayers at step 516 as described in embodiments above. As such, action items may be labeled and stored as to-do 246, active 248, and completed 250 and may further be implemented at step 518 based on the tags and storage as described above.

In some aspects, the techniques described herein relate to one or more non-transitory computer-readable media storing computer executable instructions that, when executed by at least one processor, performs a method of determining an optimal outcome. the method includes obtaining, by a calculation module at a primary layer, data points indicative of a user and a user region associated with the user and a set of government laws including federal and state laws based on the user region, wherein the data points and federal laws are stored at a sublayer, generating, by the calculation module, a user profile including the data points and the set of government laws, obtaining, by an insight module at the primary layer, the user profile, determining, by the insight module, insights from the user profile, wherein the insight module does not have direct access to the sublayer, obtaining, by a goal module at the primary layer, a set of goals from the user, generating an outcome objective based on the set of goals from the user and the insights; and determining a set of action items that maximizes the outcome objective while constraining the outcome objective to the set of government laws.

In some aspects, the techniques described herein relate to the media, wherein the set of action items is determined by at least one statistical or machine learning algorithm by maximize the outcome objective to realize the set of goals.

In some aspects, the techniques described herein relate to the media, wherein the method further includes updating at least one third-party application with an action item of the set of action items to realize at least one goal of the set of goals.

In some aspects, the techniques described herein relate to the media, wherein the method further includes generating a task list including the set of action items, and wherein completion of the task list completes the set of goals.

In some aspects, the techniques described herein relate to the media, wherein the method further includes determining a current state of the set of goals, estimating an end state of the set of goals, determining an accuracy of the end state of the set of goals, and providing further guidance to the user based on the end state of the set of goals and the accuracy of the end state of the set of goals.

In some aspects, the techniques described herein relate to the media, wherein the sublayer is a first sublayer; and wherein the method further includes determining, at a second sublayer, guidance for the user based on the insights, and providing the guidance to the user by the insight module.

In some aspects, the techniques described herein relate to the media, wherein the method further includes: determining an effect of the insights on the outcome objective, and generating the outcome objective only when the effect is above a minimum threshold.

In some aspects, the techniques described herein relate to the media, wherein the set of goals includes one of a realizing a minimum tax refund, withholding an amount from income, maximizing use of a health savings account, allocating income to a retirement fund, and allocating income to various assets.

In some aspects, the techniques described herein relate to a system for determining an optimal outcome. The system includes at least one processor, a datastore, and one or more non-transitory computer-readable media storing computer-executable instructions that, when executed by the at least one processor, perform a method of determining the optimal outcome. The method includes obtaining, by a calculation module at a primary layer, data points indicative of a user and a user region associated with the user and a set of government laws including federal and state laws based on the user region, wherein the data points and federal laws are stored at a first sublayer, generating, by the calculation module, a user profile including the data points and the set of government laws, obtaining, by an insight module at the primary layer, the user profile; determining, by the insight module, insights from the user profile, wherein the insight module does not have direct access to the first sublayer, determining, at a second sublayer, guidance for the user based on the insights; providing the guidance to the user by the insight module; obtaining, by a goal module at the primary layer, a set of goals from the user, generating an outcome objective based on the set of goals from the user and the insights, and determining a set of action items that maximizes the outcome objective while constraining the outcome objective to the set of government laws.

In some aspects, the techniques described herein relate to the system, wherein the method further includes providing the guidance automatically by a graphical user interface on a mobile device, wherein the guidance includes one or more insights of the insights.

In some aspects, the techniques described herein relate to the system, wherein the set of goals includes a tax withholding and a tax refund minimum.

In some aspects, the techniques described herein relate to the system, wherein the outcome objective maximizes a tax refund while constraining the tax withholding below a specified value.

In some aspects, the techniques described herein relate to the system, wherein the method further includes determining a current state of the tax refund; estimating an end state of the tax refund, determining an accuracy of the end state of the tax refund, and providing further guidance to the user based on the end state of the tax refund.

In some aspects, the techniques described herein relate to the system, wherein the set of goals further includes allocating funds to various assets held by the user.

In some aspects, the techniques described herein relate to the system, wherein the method further includes generating a task list including the set of action items, and wherein completion of the task list realizes the set of goals.

In some aspects, the techniques described herein relate to a method of determining an optimal outcome. The method includes obtaining, by a calculation module at a primary layer, data points indicative of a user and a user region associated with the user and a set of government laws including federal and state laws based on the user region, wherein the data points and federal laws are stored at a first sublayer, generating, by the calculation module, a user profile including the data points and the set of government laws, obtaining, by an insight module at the primary layer, the user profile, determining, by the insight module, insights from the user profile, wherein the insight module does not have direct access to the first sublayer, determining, at a second sublayer, guidance for the user based on the insights, providing the guidance to the user by the insight module; obtaining, by a goal module at the primary layer, a set of goals from the user, generating an outcome objective based on the set of goals from the user and the insights, determining a set of action items that maximizes the outcome objective while constraining the outcome objective to the set of government laws, and presenting the set of action items to the user by a graphical user interface.

In some aspects, the techniques described herein relate to the method, wherein the set of action items is determined by at least one statistical or machine learning algorithm analyzing the outcome objective.

In some aspects, the techniques described herein relate to the method, wherein the set of goals includes one of a realizing a minimum tax refund, withholding an amount from income, maximizing use of a health savings account, allocating income to a retirement fund, and allocating income to various assets.

In some aspects, the techniques described herein relate to the method, determining a current state of a tax refund, estimating an end state of the tax refund, determining an accuracy of the end state of the tax refund, and providing further guidance to the user based on the end state of the tax refund and the accuracy of the end state of the tax refund.

In some aspects, the techniques described herein relate to the method, wherein the method further includes generating a task list including the set of action items, and wherein completion of the task list completes the set of goals.

Although current disclosure has been described with reference to the embodiments illustrated in the attached drawing figures, it is noted that equivalents may be employed, and substitutions made herein without departing from the scope of the disclosure as recited in the claims.

Having thus described various embodiments, what is claimed as new and desired to be protected by Letters Patent includes the following:

1. One or more non-transitory computer-readable media storing computer executable instructions that, when executed by at least one processor, performs a method of determining an optimal outcome, the method comprising:
obtaining, by a calculation module at a primary layer, data points indicative of a user and a user region associated with the user and a set of government laws comprising federal and state laws based on the user region,
wherein the data points and federal laws are stored at a sublayer;
generating, by the calculation module, a user profile comprising the data points and the set of government laws;
obtaining, by an insight module at the primary layer, the user profile;
determining, by the insight module, insights from the user profile,
wherein the insight module does not have direct access to the sublayer;
obtaining, by a goal module at the primary layer, a set of goals from the user;
generating an outcome objective based on the set of goals from the user and the insights; and
determining a set of action items that maximizes the outcome objective while constraining the outcome objective to the set of government laws.

2. The media of claim 1, wherein the set of action items is determined by at least one statistical or machine learning algorithm by maximize the outcome objective to realize the set of goals.

3. The media of claim 2, wherein the method further comprises updating at least one third-party application with an action item of the set of action items to realize at least one goal of the set of goals.

4. The media of claim 2,
wherein the method further comprises generating a task list comprising the set of action items, and
wherein completion of the task list completes the set of goals.

5. The media of claim 1, wherein the method further comprises:
determining a current state of the set of goals;
estimating an end state of the set of goals;
determining an accuracy of the end state of the set of goals; and
providing further guidance to the user based on the end state of the set of goals and the accuracy of the end state of the set of goals.

6. The media of claim 1,
wherein the sublayer is a first sublayer; and
wherein the method further comprises:
determining, at a second sublayer, guidance for the user based on the insights; and
providing the guidance to the user by the insight module.

7. The media of claim 1, wherein the method further comprises:
determining an effect of the insights on the outcome objective; and
generating the outcome objective only when the effect is above a minimum threshold.

8. The media of claim 1, wherein the set of goals comprises one of a realizing a minimum tax refund, withholding an amount from income, maximizing use of a health savings account, allocating income to a retirement fund, and allocating income to various assets.

9. A system for determining an optimal outcome, the system comprising:
at least one processor;
a datastore; and
one or more non-transitory computer-readable media storing computer-executable instructions that, when executed by the at least one processor, perform a method of determining the optimal outcome, the method comprising:
obtaining, by a calculation module at a primary layer, data points indicative of a user and a user region associated with the user and a set of government laws comprising federal and state laws based on the user region,
wherein the data points and federal laws are stored at a first sublayer;
generating, by the calculation module, a user profile comprising the data points and the set of government laws;
obtaining, by an insight module at the primary layer, the user profile;
determining, by the insight module, insights from the user profile,
wherein the insight module does not have direct access to the first sublayer;
determining, at a second sublayer, guidance for the user based on the insights;
providing the guidance to the user by the insight module;
obtaining, by a goal module at the primary layer, a set of goals from the user;
generating an outcome objective based on the set of goals from the user and the insights; and
determining a set of action items that maximizes the outcome objective while constraining the outcome objective to the set of government laws.

10. The system of claim 9, wherein the method further comprises:
providing the guidance automatically by a graphical user interface on a mobile device,
wherein the guidance comprises one or more insights of the insights.

11. The system of claim 9, wherein the set of goals includes a tax withholding and a tax refund minimum.

12. The system of claim 9, wherein the outcome objective maximizes a tax refund while constraining the tax withholding below a specified value.

13. The system of claim 12, wherein the method further comprises:
determining a current state of the tax refund;
estimating an end state of the tax refund;
determining an accuracy of the end state of the tax refund; and
providing further guidance to the user based on the end state of the tax refund.

14. The system of claim 13, wherein the set of goals further comprises allocating funds to various assets held by the user.

15. The system of claim 9,
wherein the method further comprises generating a task list comprising the set of action items, and
wherein completion of the task list realizes the set of goals.

16. A method of determining an optimal outcome, the method comprising:
obtaining, by a calculation module at a primary layer, data points indicative of a user and a user region associated with the user and a set of government laws comprising federal and state laws based on the user region,
wherein the data points and federal laws are stored at a first sublayer;
generating, by the calculation module, a user profile comprising the data points and the set of government laws;
obtaining, by an insight module at the primary layer, the user profile;
determining, by the insight module, insights from the user profile,
wherein the insight module does not have direct access to the first sublayer;
determining, at a second sublayer, guidance for the user based on the insights;
providing the guidance to the user by the insight module;
obtaining, by a goal module at the primary layer, a set of goals from the user;
generating an outcome objective based on the set of goals from the user and the insights;
determining a set of action items that maximizes the outcome objective while constraining the outcome objective to the set of government laws; and
presenting the set of action items to the user by a graphical user interface.

17. The method of claim 16, wherein the set of action items is determined by at least one statistical or machine learning algorithm analyzing the outcome objective.

18. The method of claim 16, wherein the set of goals comprises one of a realizing a minimum tax refund, withholding an amount from income, maximizing use of a health savings account, allocating income to a retirement fund, and allocating income to various assets.

19. The method of claim 16,
determining a current state of a tax refund;
estimating an end state of the tax refund;
determining an accuracy of the end state of the tax refund; and
providing further guidance to the user based on the end state of the tax refund and the accuracy of the end state of the tax refund.

20. The method of claim 16,
wherein the method further comprises generating a task list comprising the set of action items, and
wherein completion of the task list completes the set of goals.
